(19) United States
(12) Patent Application Publication
(10) Pub. No.: US 2002/0093487 A1
(43) Pub. Date: Jul. 18, 2002

(54) Optical mouse

(76) Inventor: Armand David Rosenberg, Rehovot (IL)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 09/814,113

(22) Filed: Mar. 22, 2001

Related U.S. Application Data
(60) Provisional application No. 60/261,258, filed on Jan. 16, 2001.

(51) Int. Cl. G09G 5/08

(52) U.S. Cl. 345/166

(57) ABSTRACT

An apparatus for an optical mouse for use with control systems, which is environmentally sealed and durable and therefore, suited for industrial and/or harsh environmental uses.

### PRIORITY

The following application claims priority from U.S. Provisional Application Serial No. 60/261,258 filed on Jan. 16, 2001, the disclosure of which is incorporated herein by reference.

### FIELD OF INVENTION

The present invention relates generally to computer peripheral devices. More particularly, the present invention relates to an optical mouse mechanism for use with a computer system.

### BACKGROUND OF THE INVENTION

Computer mouse tracking devices, such as mice for personal computers, main frames, notebooks, and the like generally include either a capacitive, optical, or electro-mechanical mechanism which tracks the user's movements and mimics these motions onto a computer monitor in order to position the cursor/pointer as desired. In existing tracking devices, the tracking device may be connected to the computer system by wired connections which are not durably constructed and are not sealed. These devices are therefore susceptible to being damaged by physical trauma or contaminants and, thus, not optimal for use in industrial or other environments where the device may be subject to harsh treatment or contaminants.

For instance, various industrial environments utilize computer systems for robotic automation, assembly line production and monitoring, performing environmental sensory inputs and performing pressure and/or radiation sensitive testing. These computer systems may require keyboard and mouse inputs from a user. It would therefore be beneficial to have a durable keyboard and mouse input device in order to minimize any downtime due to environmental contaminants or industrial accidents damaging the keyboard and mouse.

While currently existing keyboards and mice may be easy to replace, the time it takes to do so can be cumulative and hence can become a financial burden when productivity time is lost. A need still exists, therefore, for a durable computer mouse tracking device.

### SUMMARY OF THE INVENTION

The foregoing need has been met, to a great extent, by the present invention where in one aspect an optical mouse is provided having an environmentally sealed housing having a tracking plate provided therein. A light generation source is provided within the housing to transmit a light source through the tracking plate. A sensor, also provided within the housing, receives light from the light source reflected from objects passing over the tracking plate. A band pass filter is provided between the tracking plate and the sensor to attenuate ambient light passing through the tracking plate and being received by the sensor.

It is another aspect of the present invention to provide a keyboard optical mouse tracking device that utilizes an infrared filter interface which reduces the ambient light entering the optics area of the tracking device thereby lowering the “electronic noise” being received by the microprocessor controller and thereby increasing the accuracy of inputs transmitted by the mouse tracking device and subsequently received by the controller, thus enhancing the accuracy of the computer system's on-screen cursor/pointer.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purposes of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent construction insofar as they do not depart from the spirit and scope of the present invention.

### BRIEF DESCRIPTION OF THE DRAWINGS

FIG. 1 provides a cross sectional view of an optical mouse of a preferred embodiment of the present invention.

FIG. 2 is a circuit diagram showing a preferred embodiment of the present invention.

FIG. 3 is a circuit diagram showing an alternate embodiment of the present invention including mouse switch button inputs to the controller.

FIG. 4 is a circuit diagram showing yet another embodiment of the present invention including a battery-powered wireless keyboard optical mouse configuration.

FIG. 5 is a cross sectional view of an alternate embodiment of the present invention which includes a band pass filter interface to the optics area.

FIG. 6 is a graphical representation of the specifications of the band pass filter of FIG. 5.

### DETAILED DESCRIPTION OF THE INVENTION

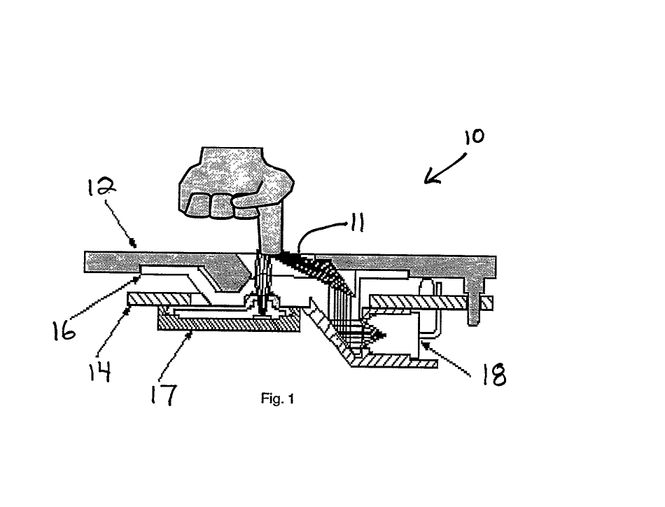

Referring now to the figures, wherein like reference numerals indicate like elements, in FIG. 1 there is shown an optical mouse 10 in accordance with a preferred embodiment of the present invention. The optical mouse 10 includes an environmentally sealed housing plate 12, a printed circuit board 14, an optical movement sensor 17, a light emitting diode (LED) 18, a light conduit 16, and a tracking plate 11.

The printed circuit board 14 is located beneath the tracking plate 11 and includes electrical circuit connections to the optical movement sensor 17. An LED 18 of the wave matching type which is electrically connected to the printed circuit board 14 transmits light through the light conduit 16, which is disposed on the printed circuit board 14. The light conduit 16 directs the light transmitted from the LED 18 toward the tracking plate 11 and the light reflected from an object passed over the tracking plate, e.g., a user's finger, towards the optical movement sensor 17. As depicted in FIG. 1, the user physically touches the tracking plate 11 which causes light from the LED 18 to be reflected onto the movement sensor 17. The sensor provides data to the computer cursor/pointer circuitry which has outputs 24 to a computer (not shown).

The movement sensor 17 may be any device that is capable of responding to optical motion inputs. In the preferred embodiment, the movement sensor is the solid state optical mouse sensor with PS/2 and quadrature outputs, Part No. HDNS-2000 distributed by Agilent Technologies. It should readily be apparent that the foregoing example of a movement sensor is merely illustrative and is not meant to be limiting.

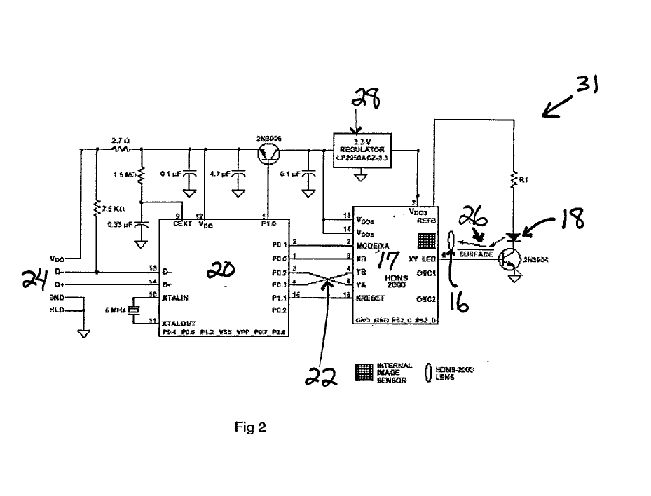

In FIG. 2 there is shown a circuit diagram of an electronics package 31 which includes a microprocessor controller 20; a circuit input 22; an optics area 26 which includes LED 18, light conduit 16 and tracking plate 11 described above; a voltage regulator 28; and outputs 24 to a computer. The optics area 26 transmits the LED 18 light that is reflected off the object passing over the tracking plate 11 and is subsequently received by the optical movement sensor 17. The optical movement sensor 17 then transmits an output along the horizontal motion lines XA and XB and the vertical motion lines YA and YB to the microprocessor controller 20.

The microprocessor controller 20 receives the XA and XB transmissions from the optical movement sensor 17 to its P0.1 and P0.0 input pins, respectively. However, the microprocessor controller 20 receives the YA and YB transmissions from the optical movement sensor 17 to its P0.3 and P0.2 input pins, respectively (i.e., instead of having the conventional connections of the YA output to the P0.2 input and the YB output to the P0.3 input, the YA and YB outputs are connected in a reverse manner). This “reverse” connection is needed in that conventional optical mice have the LED transmission facing downward while the keyboard optical mouse 10 of the present invention has the LED transmission facing upward. This upward configuration causes the user's forward and backward motions to be interpreted as downward and upward cursor movements, respectively, unless the “reverse” connections are made between the vertical motion outputs YA and YB of the optical movement sensor 17 and the P0.2 and P0.3 inputs to the microprocessor controller 20 as generally shown in FIG. 2 at circuit inputs 22.

A voltage regulator 28 (preferably at 3.3 volts) provides power to the electronics package 31. An output 24 is provided to a computer system interface (not shown) from the microprocessor controller 20 by way of the keyboard interface (not shown). This keyboard interface may be of the PS/2 type or a USB configuration.

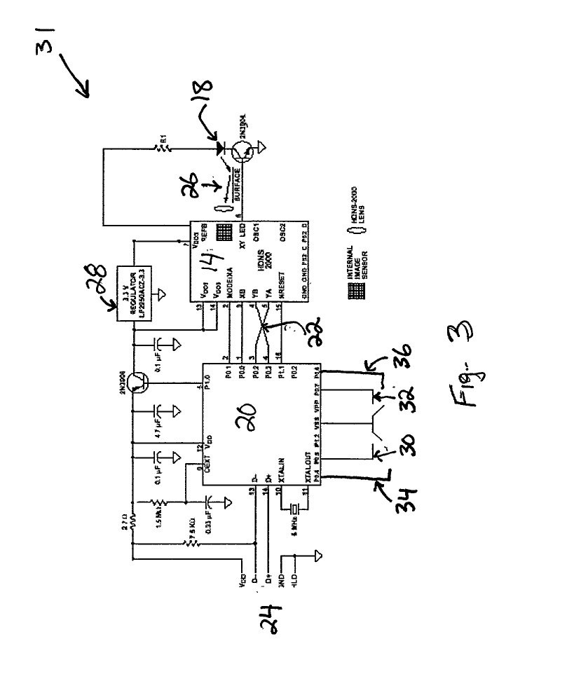

The microprocessor controller 20 may be any device that is capable of receiving serial inputs through an input bus and producing controlled outputs to either a computer system directly or through an antenna-transponder connection for wireless data transmission. In the preferred embodiment, the microprocessor controller is a universal serial bus microcontroller, Part No. CY7C63000A distributed by Cypress Semiconductor Corporation. It should readily be apparent that the foregoing example of a movement sensor is merely illustrative and is not meant to be limiting. An alternate embodiment of the mouse is shown in FIG. 3 and includes mouse switch inputs 30, 32, commonly referred to as the right click and left click buttons.

In the preferred embodiment, the right and left mouse click switches 30, 32 are interdisposed between a common power supply pin, Vss, and data input lines P0.5 and P0.7. An up and down “scroll” feature can also be provided in the mouse of the present invention. These features can be provided using switches 34, 36 interdisposed between a common power supply Vss and data input lines P0.4 and P0.6. The scroll feature can be implemented so that actuating one switch causes the cursor to scroll up and the other switch causes the cursor to scroll down. Alternatively, the scroll feature can be implemented so that both switches must be actuated in a particular sequence to scroll, e.g., actuate one switch then actuate and hold the other switch.

The switches 30, 32, 34, 36 may be any device that is capable of receiving user inputs and is preferably the switches described in U.S. Pat. No. 4,896,069. The switches 30, 32, 34, 36 may be used in a similar manner as conventional mouse inputs (i.e., programmable, single and double click applications, scrolling, etc.). However, these switches 30, 32, 34, 36 are incorporated into the present invention which is environmentally sealed and durable and, thus, can sustain harsh industrial or other environments.

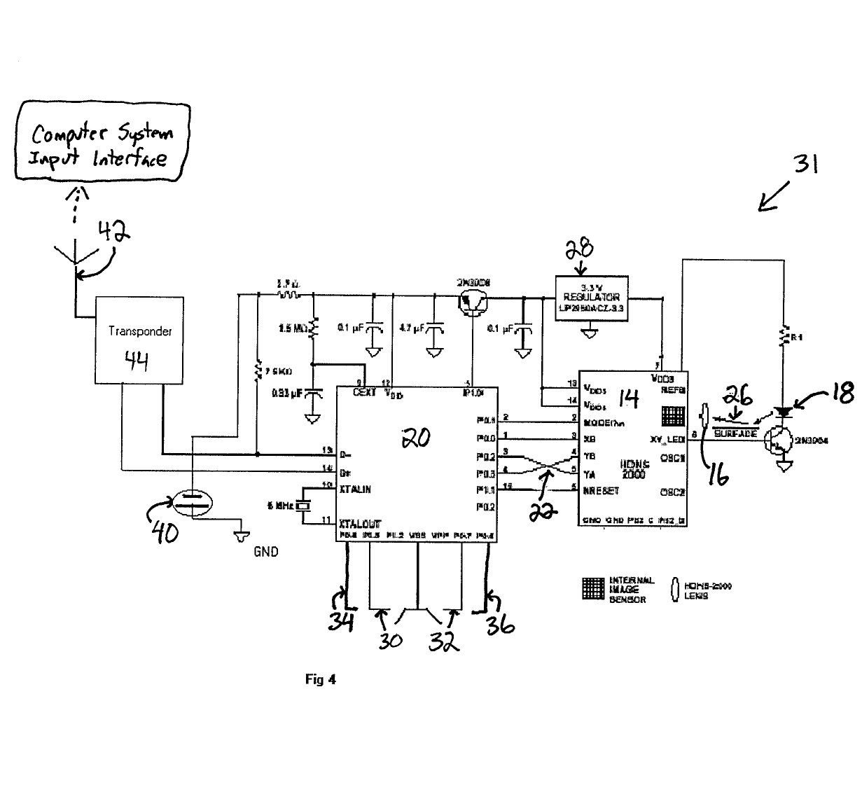

Another embodiment of the invention as shown in FIG. 4, includes a wireless mouse powered by a battery 40. Signals are transmitted from, and received by, the wireless mouse via a transmitter antenna 42 connected to a Bluetooth transponder 44. Details of the Bluetooth specification are readily available, e.g., at www.bluetooth.com, and are incorporated herein by reference. It should be readily understood that the wireless mouse could also be incorporated into a wireless keyboard for use in connection with such applications as webTV.

One of many advantages of such a wireless configuration is to allow a user the freedom of not having to be directly connected to a computer system through a wired connection. Another advantage of a wireless configuration is to allow a user to operate either a control system or computer system from a safe vantage point, especially if the control system or computer system is proximal to harsh or dangerous environments such as temperature or radiation sensitive areas that could harm the user.

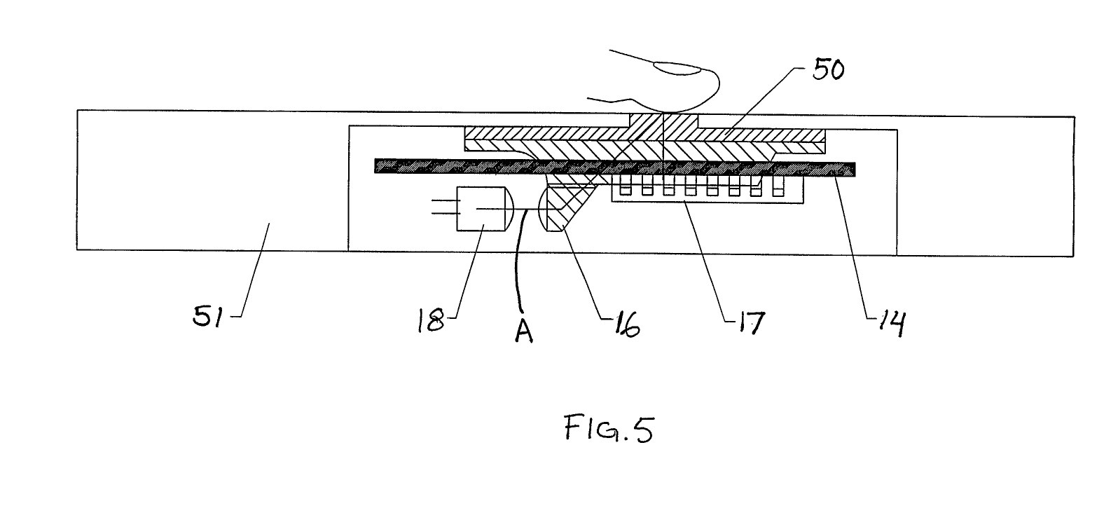

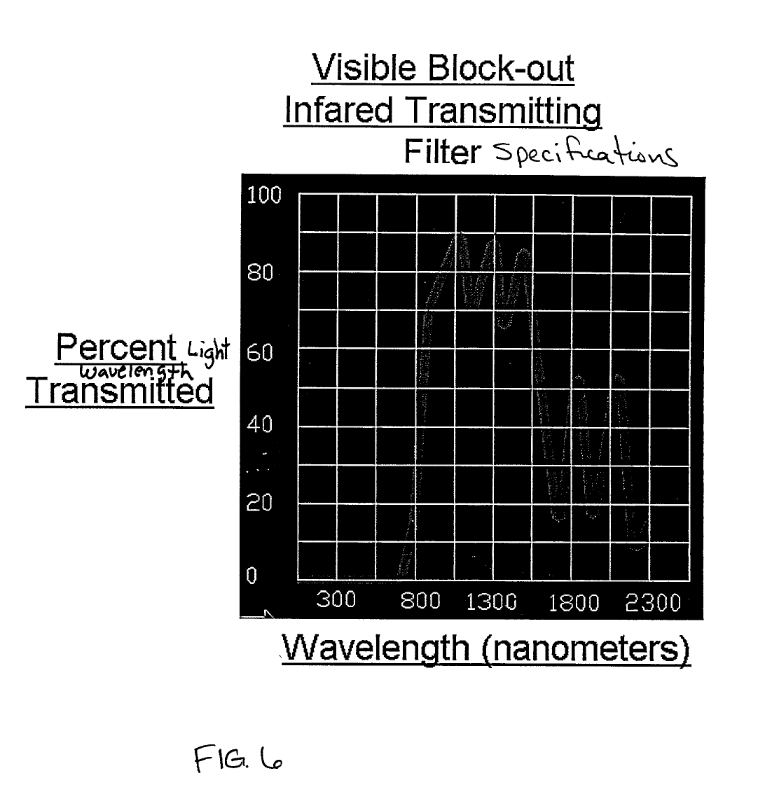

Referring to FIG. 5, an alternate embodiment of the invention is shown which includes a band pass filter 50 for attenuating external ambient light noise which could unintentionally cause the keyboard optical mouse's cursor/pointer to move on the computer screen (not shown) without the user input being present. The filter is mounted in the housing 51 above the printed circuit board 14 and acts as the tracking plate interface between the user and the printed circuit board 14. Again, this alternate embodiment includes a light conduit 16 which transmits the light from the LED 18 to the filter/tracking plate 50 back to the movement sensor 17 as indicated by line A. In a preferred embodiment, the infrared filter 50 highly attenuates the ambient light and passes only the infrared light generated by the LED 18, thereby decreasing the chances of any ambient light interfering with the inputs to the computer system's cursor/pointer inadvertently. FIG. 6 graphically depicts the attenuation characteristics of the filter of a preferred embodiment of the present invention. It can be seen that this filter passes light in the range of approximately 800 to 1550 nanometers. It should be readily understood that the optical mouse of the present invention can be embodied either as a stand alone device or can be incorporated directly into a keyboard. While having particular advantages when used in industrial environments, it is also envisioned that the present invention will be utilized in other applications such as laptop computers and hand held organizers. As such, it is envisioned that the presently described optical mouse may be embodied as a standalone mouse device with a plastic housing. It should also be recognized that the circuitry of the present invention can be utilized in any application for controlling movement, e.g., control of a robotic arm, etc.

The above description and drawings are only illustrative of preferred embodiments which achieve the objects, features, and advantages of the present invention, and it is not intended that the present invention be limited thereto. Any modification of the present invention which comes within the spirit and scope of the following claims is considered to be part of the present invention.

What is claimed is:

1. An optical mouse comprising:
a housing having a tracking plate provided therein;
a light generation source provided within said housing and transmitting a light source through said tracking plate;
a sensor provided within said housing for receiving light from said light source reflected from objects passing over said tracking plate.

2. The optical mouse of claim 1, further comprising a band pass filter provided between said tracking plate and said sensor to attenuate ambient light passing through the tracking plate and being received by the sensor.

3. The optical mouse of claim 2, wherein said mouse is incorporated into a keyboard.

4. The optical mouse of claim 2, wherein said light generation source is an LED.

5. The optical mouse of claim 4, further including a data input switch.

6. The optical mouse of claim 5, wherein said switch is a scroll data input switch.

7. The optical mouse of claim 5, wherein said mouse is incorporated into a keyboard.

8. An optical mouse comprising:
a housing having a tracking plate provided therein;
a light generation source provided within said housing and transmitting a light source through said tracking plate;
a sensor provided within said housing for receiving light from said light source reflected from objects passing over said tracking plate; and
wherein said tracking plate is a band pass filter which attenuates ambient light passing through the tracking plate to said sensor.

9. The optical mouse of claim 8, wherein said light generation source is an LED.

10. The optical mouse of claim 9, further comprising a first data input switch.

11. The optical mouse of claim 10, further comprising a second data input switch.

12. The optical mouse of claim 11, wherein said mouse is incorporated into a keyboard.

13. A method of providing mouse input data to a control system, comprising the steps of:
transmitting a light source through a window of a stationary mouse device;
detecting said transmitted light at a sensor in said mouse device when reflected from an object passing over said window;
tracking said object passing over said window in both the longitudinal and transverse directions; and
providing to said control system data corresponding to longitudinal and transverse movements across said window.

14. The method of claim 13, further comprising the step of:
filtering said light source from said window.

15. The method of claim 14, further comprising the step of:
using an infrared filter to filter said light source.

16. The method of claim 15, further comprising the step of:
connecting mouse click inputs to said infrared filter.

17. The method of claim 16, wherein said mouse click inputs include a force activated sensor.

18. The method of claim 13, further comprising the step of:
connecting scrolling inputs to said stationary mouse device.

19. The method of claim 18, wherein said scrolling inputs comprise at least two motion sensors.

20. The method of claim 14, further comprising the steps of:
transmitting said data to said control system through a wireless transmission configuration.

21. The method of claim 20, wherein said wireless transmission configuration comprises a transponder connected to an antenna.
